(19) United States
(12) Patent Application Publication
(10) Pub. No.: US 2008/0017837 A1
(43) Pub. Date: Jan. 24, 2008

(54) Screw-in Conduit Puller

(76) Inventor: Vincent Christopher Steele, Parkville, MD (US)

Correspondence Address: Vincent Christopher Steele, 2006 Taylor Ave., Parkville, MD, 21234, US

(21) Appl. No.: 11/459,350

(22) Filed: Jul. 22, 2006

(51) Int. Cl. B66F 13/00

(52) U.S. Cl. 254/1

(57) ABSTRACT

The invention described herein is a device for the installation of electrical conduit. It consists of an adaptor portion that interfaces with and connects to electrical conduit. On the opposite end of the device lies an appendage to which a guiding line can attach. A handle portion permits easy manipulation for both screwing and unscrewing of the adaptor and a flange portion prevents excessive and unnecessary screwing.

The Screw-in Conduit Puller is a device that aids in the installation of electrical conduit in wall spaces. The prevailing method of installing electrical conduit consists of attaching a guiding line, such as fish tape, to the end of a conduit and then using the line to position the conduit. In order to attach the fish tape to the end of the conduit, it is routine to employ electrical tape, duct tape, or other such adhesive tapes. The invention described herein provides a significant improvement over the current practice. It consists of an adapter which screws into the end of a conduit and on the opposite side of the adapter is an appendage to which a guiding line, like fish tape, can be attached. This conduit pulling device provides a more efficient method of installation: it requires no expenditure of adhesive tape, there is no risk of the guide line slipping out from underneath a taped mooring, it blunts the end of the conduit during installation so that the sharp edge of the conduit will not get caught or cause damage while being installed, and it also saves a significant amount of time.

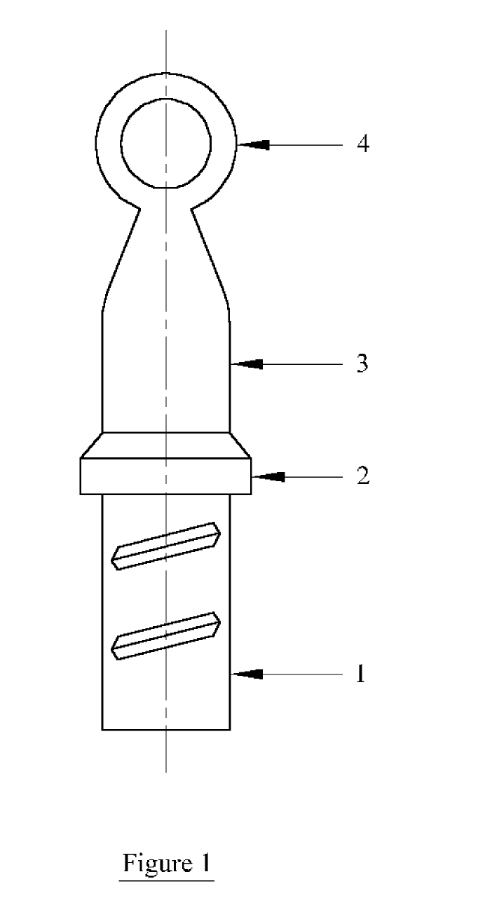

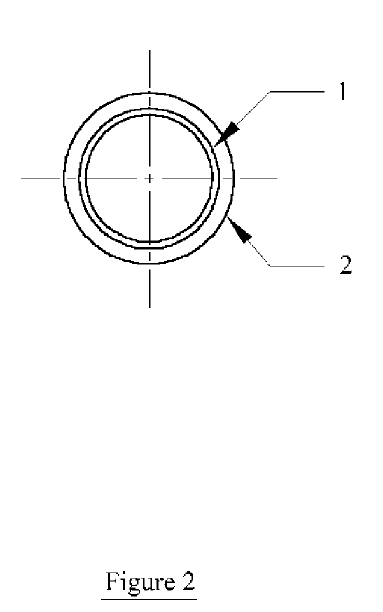

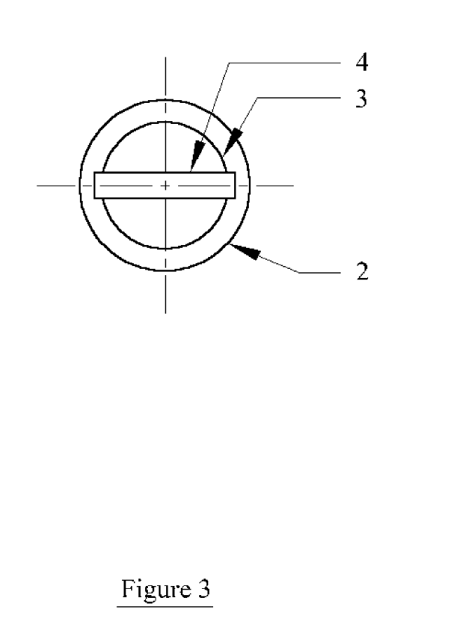

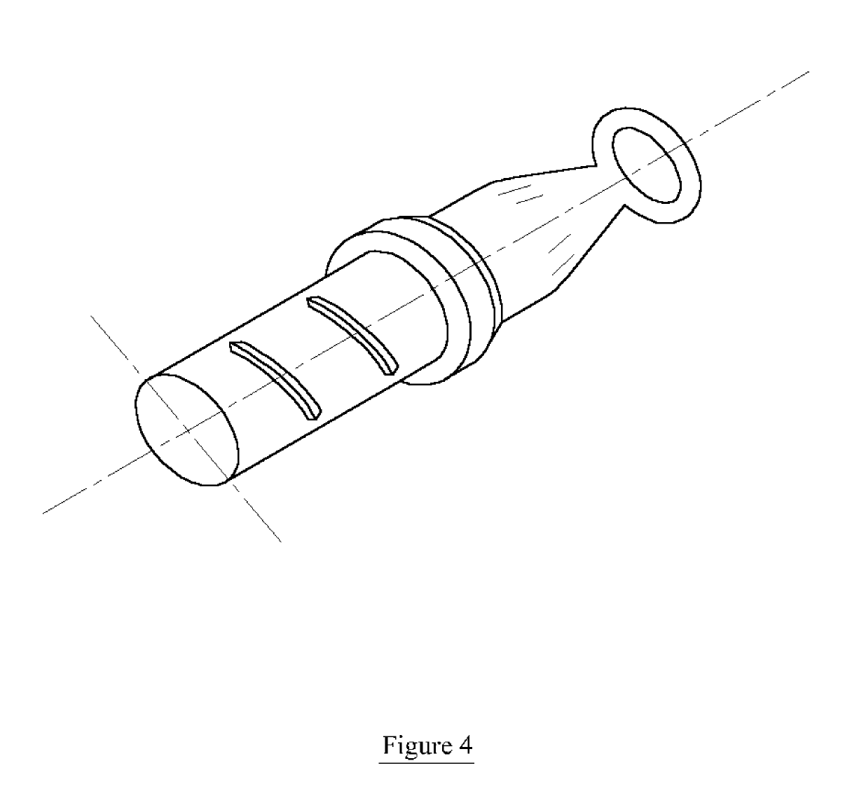

The preferred embodiment consists of a screw-in adaptor 1 in FIG. 1 that can interface with the inside of an electrical conduit. The adaptor portion interfacing with the inside of an electrical conduit consists of a short cylinder with external threading enabling the adaptor to screw into the conduit and form a strong bond with the conduit. The cylinder should be at least ¾ inch long so that there is a secure interface between the adaptor and the conduit. Opposite the adaptor portion, a loop 4 in FIG. 1, that is preferably torus shaped, provides a convenient attachment for the fish tape or other guiding mechanism. Between the adaptor portion and the loop, should be a flange 2 in FIG. 1. The flange serves two functions: it provides a natural barrier preventing an unnecessary amount of screwing into the conduit and it blunts the sharp end of the conduit. Between the flange and the loop lies the portion of the device that is to be manipulated with the hand 3 in FIG. 1. It should be of sufficient width and friction so as to permit the screwing and unscrewing of the device from conduit. The conduit puller can be constructed of almost any type of material so long as the friction between the adaptor and the conduit is not excessive. Almost any hard metal or plastic should work well. FIG. 2 is an end view of the invention, displaying the cylinder portion 1 and the flange portion 2. FIG. 3 displays the end opposite of that shown in FIG. 2, displaying the loop portion 4 and the handle portion 3. FIG. 4 provides an orthographic view of the entire invention.

The procedure for using the conduit puller consists of screwing the adaptor portion of the puller 1 in FIG. 1 into one end of an electrical conduit using the handle portion 3 in FIG. 1. The screwing is halted where the conduit meets the flange 2 in FIG. 1. A guiding line, e.g. fish tape, is then run between the walls where the conduit is to be installed. Where the end of the fish tape has exited the wall, the torus shaped loop of the conduit puller 4 in FIG. 1 is attached to the hook of the fish tape and the conduit is then pulled into place.

A conduit pulling adaptor device consisting of one end that screws into the end of an electrical conduit and an opposite end consisting of an appendage capable of attachment to a guiding line or fish tape for the installation of said conduit.

A device as in claim 1, in which between the two ends is situated a flange.

A device as in claim 1, in which the end of the adaptor that screws into the conduit mates with the interior of the conduit.

A device as in claim 1, in which the end of the adaptor that screws into the conduit mates with the exterior of the conduit.

A device as in claim 1, in which the end consisting of the appendage capable of attachment to a guiding line or fish tape forms a loop.

A device as in claim 5, in which the appendage is approximately torus shaped.

A device as in claim 2, in which the end of the adaptor that screws into the conduit mates with the interior of the conduit.

A device as in claim 2, in which the end of the adaptor that screws into the conduit mates with the exterior of the conduit.

A device as in claim 2, in which the end consisting of the appendage capable of attachment to a guiding line or fish tape forms a loop.

A device as in claim 9, in which the appendage is approximately torus shaped.

The invention described herein is a device for the installation of electrical conduit. It consists of an adaptor portion that interfaces with and connects to electrical conduit. On the opposite end of the device lies an appendage to which a guiding line can attach. A handle portion permits easy manipulation for both screwing and unscrewing of the adaptor and a flange portion prevents excessive and unnecessary screwing.

I claim:

1. A conduit pulling adaptor device consisting of one end that screws into the end of an electrical conduit and an opposite end consisting of an appendage capable of attachment to a guiding line or fish tape for the installation of said conduit.

2. A device as in claim 1, in which between the two ends is situated a flange.

3. A device as in claim 1, in which the end of the adaptor that screws into the conduit mates with the interior of the conduit.

4. A device as in claim 1, in which the end of the adaptor that screws into the conduit mates with the exterior of the conduit.

5. A device as in claim 1, in which the end consisting of the appendage capable of attachment to a guiding line or fish tape forms a loop.

6. A device as in claim 5, in which the appendage is approximately torus shaped.

7. A device as in claim 2, in which the end of the adaptor that screws into the conduit mates with the interior of the conduit.

8. A device as in claim 2, in which the end of the adaptor that screws into the conduit mates with the exterior of the conduit.

9. A device as in claim 2, in which the end consisting of the appendage capable of attachment to a guiding line or fish tape forms a loop.

10. A device as in claim 9, in which the appendage is approximately torus shaped.
